(19) United States
(12) Patent Application Publication
(10) Pub. No.: US 2026/0228915 A1
(43) Pub. Date: Aug. 6, 2026

(54) CALIBRATION PARAMETER GENERATING SYSTEM AND METHOD

(71) Applicant: HTC Corporation, Taoyuan City (TW)

(72) Inventors: Ching-Jung HUNG, Taoyuan City (TW); Chao-Shuan HUANG, Taoyuan City (TW)

(21) Appl. No.: 19/043,513

(22) Filed: Feb. 2, 2025

(51) Int. Cl. G06T 7/80; G06T 7/00

(52) U.S. Cl. CPC G06T 7/80; G06T 7/97

(57) ABSTRACT

A calibration parameter generating system and method are provided. The system receives calibration image frames from image capturing devices, each of the calibration image frames at least includes a feature sub-pattern on at least one curved surface corresponding to a calibration object, and the feature sub-pattern is a part of at least one feature pattern. The system generates a calibration parameter of each of the image capturing devices based on the feature sub-pattern of each of the calibration image frames.

### BACKGROUND

### Field of Invention

The present invention relates to a calibration parameter generating system and method. More particularly, the present invention relates to a calibration parameter generating system and method that can correctly generating a plurality of calibration parameters.

### Description of Related Art

Multi-camera systems (e.g., ultra-wide angle FOV camera arrays) are often used in computer vision applications such as simultaneous localization and mapping (SLAM) and posture capturing. In order for the operation to be performed accurately, the parameters of each camera in the system need to be correctly calibrated.

In the prior art, each camera can perform calibration operations by photographing a feature pattern on a traditional flat calibration plate. However, since the camera located on the back of the flat calibration plate cannot capture the feature pattern on the calibration plate, the calibration operation cannot be performed correctly. In other words, conventional flat calibration plates can only support camera calibration within a 180-degree outward line of sight of the flat calibration plate, which makes it impossible to perform panoramic calibration for any multi-camera array with a shooting angle greater than 180 degrees.

In addition, in the prior art, the polyhedron calibration structure still causes calculation errors due to the observation angle of some correction surfaces captured by the camera being too large, making the image unclear and causing calculation errors (e.g., the multi-camera system captures multiple correction surfaces at multiple seams on a polyhedral structure), and making it impossible to correctly perform the parameter calibration. Accordingly, there is an urgent need for a calibration parameter generating technology that can correctly generate calibration parameters.

### SUMMARY

An objective of the present disclosure is to provide a calibration parameter generating system. The calibration parameter generating system comprises a calibration object, a plurality of image capturing devices, and a processing device, and the processing device is communicatively connected to the plurality of image capturing devices. The calibration object comprises at least one curved surface, and each of the at least one curved surface comprises at least one feature pattern. The processing device receives a plurality of calibration image frames from the plurality of image capturing devices, wherein each of the calibration image frames at least comprises a feature sub-pattern on the at least one curved surface corresponding to a calibration object, and the feature sub-pattern is a part of the at least one feature pattern. The processing device generates a calibration parameter of each of the image capturing devices based on the feature sub-pattern of each of the calibration image frames.

Another objective of the present disclosure is to provide a calibration parameter generating method, which is adapted for use in a calibration parameter generating system. The calibration parameter generating system comprises a calibration object, a plurality of image capturing devices, and a processing device, the calibration object comprises at least one curved surface, and each of the at least one curved surface comprises at least one feature pattern. The calibration parameter generating method comprises the following steps: receiving, by the processing device, a plurality of calibration image frames from the plurality of image capturing devices, wherein each of the calibration image frames at least comprises a feature sub-pattern on the at least one curved surface corresponding to a calibration object, and the feature sub-pattern is a part of the at least one feature pattern; and generating, by the processing device, a calibration parameter of each of the image capturing devices based on the feature sub-pattern of each of the calibration image frames.

According to the above descriptions, the calibration parameter generation technology (at least including the system and the method) provided by the present disclosure sets a calibration object including at least one curved surface in the system to provide each image capturing device in the system with a recognizable viewing angle without blind spots (i.e., the recognizable viewing angle is 360 degrees). Next, the processing device in the system generates a calibration parameter of each of the image capturing devices based on a plurality of calibration image frames including feature sub-patterns on the at least one curved surface of the calibration object. Since the calibration parameter generating technology provided by the present disclosure can provide a multi-camera array with a shooting angle greater than 180 degrees for panoramic calibration, a full-angle calibration effect can be achieved. In addition, the new calibration object structure solves the blind spot and viewpoint bias when using flat/polyhedron calibration charts. Accordingly, the calibration parameter generating technology provided by the present disclosure can correctly generate calibration parameters, thereby improving the accuracy of device execution operations and enhancing the user's service experience.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting a calibration parameter generating system of the first embodiment;

FIG. 2 is a schematic view depicting a processing device of some embodiment;

FIG. 3A is a schematic view depicting a calibration object of some embodiment;

FIG. 3B is a schematic view depicting a calibration object of some embodiment;

FIG. 4A is a schematic view depicting a calibration object of some embodiment;

FIG. 4B is a schematic view depicting a calibration object of some embodiment;

FIG. 5A is a schematic view depicting a calibration object of some embodiment;

FIG. 5B is a schematic view depicting a calibration object of some embodiment; and

FIG. 6 is a partial flowchart depicting a calibration parameter generating method of the second embodiment.

### DETAILED DESCRIPTION

In the following description, a calibration parameter generating system and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

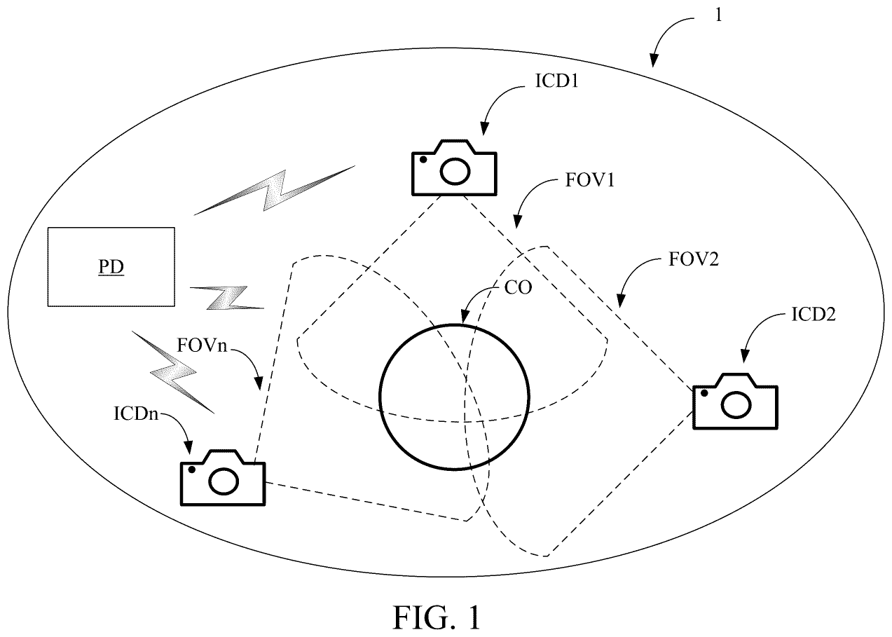

First, a first embodiment of the present disclosure is a calibration parameter generating system 1 and a schematic view of which is depicted in FIG. 1. In the present embodiment, the calibration parameter generating system 1 comprises a calibration object CO, a processing device PD, and a plurality of image capturing devices ICD1, ICD2, . . . , ICDn, and n is a positive integer. The processing device PD is communicatively connected to the image capturing devices ICD1, ICD2, . . . , ICDn.

As shown in FIG. 1, the image capture devices ICD1, ICD2, . . . , ICDn can be set at different locations in the environment/electronic device, and generate corresponding image frames at different multiple image capture angles.

It shall be appreciated that in some embodiments, the image capturing devices ICD1, ICD2, . . . , ICDn may be a multi-camera array (e.g., inside-out multi-camera array) disposed on an electronic device. In some embodiments, the image capturing devices ICD1, ICD2, . . . , ICDn may be a multi-camera array disposed in an environment (e.g., outside-in multi-camera array).

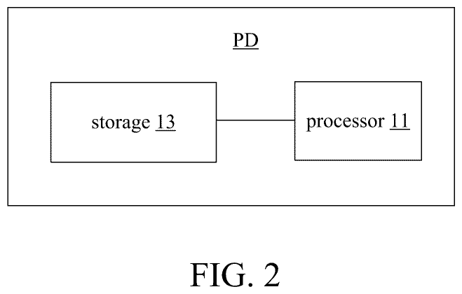

In some embodiments, a schematic diagram of the architecture of the processing device PD is depicted in FIG. 2. The processing device PD comprises a processor 11 and a storage 13. The processor 11 is electrically connected to the storage 13.

It shall be appreciated that the processor 11 may be any of various processors, Central Processing Units (CPUs), microprocessors, digital signal processors or other computing apparatuses known to those of ordinary skill in the art. The storage 13 may be a memory, a Universal Serial Bus (USB) disk, a hard disk, a Compact Disk (CD), a mobile disk, or any other storage medium or circuit known to those of ordinary skill in the art and having the same functionality. The image capturing devices ICD1, ICD2, . . . , ICDn may be image capturing devices with an image capturing function (e.g., a plurality of depth camera lenses) to generate a plurality of real-time images corresponding to a field of view (FOV) to perform a self-positioning operation of inside-out tracking.

For example, as shown in FIG. 1, the image capturing device ICD1 has a field of view FOV1, the image capturing device ICD2 has a field of view FOV2, and the image capturing device ICDn has a field of view FOVn. In the present example, the shooting angle of the multi-camera array composed of image capturing devices ICD1, ICD2, . . . , ICDn is greater than 180 degrees.

It shall be appreciated that the present disclosure does not limit the number of image capturing devices included in the calibration parameter generating system 1 and the locations where they are set. Furthermore, in some embodiments, the processing device PD may be integrated into an electronic device on which the image capturing devices ICD1, ICD2, ICDn are disposed. In some embodiments, the electronic device may be a head mounted display or a tracking device, and the head mounted display or the tracking device generates calibration parameters to calibrate its own plurality of image capturing devices.

Next, the following paragraphs will describe the specific details of the calibration parameter generating system 1 generating the calibration parameters of each of the image capturing devices in the present embodiment.

First, in the present embodiment, the calibration object CO comprises at least one curved surface, and each of the at least one curved surface comprises at least one feature pattern.

It shall be appreciated that each feature pattern may have a different geometric shape, each feature pattern has a uniquely identifiable feature, and each feature pattern is used for subsequent feature comparison operations. The feature pattern may comprise a plurality of feature sub-patterns (e.g., a portion of the feature pattern), each of the feature sub-patterns has a unique identifiable feature. In addition, the feature pattern can be modified according to the user's camera requirements, such as traditional printing, IRLED, or any other optical emitter.

In some embodiments, the calibration object CO corresponds to one of a cylindrical shape, a curved shape, a spherical shape, and a ring shape, or a combination thereof.

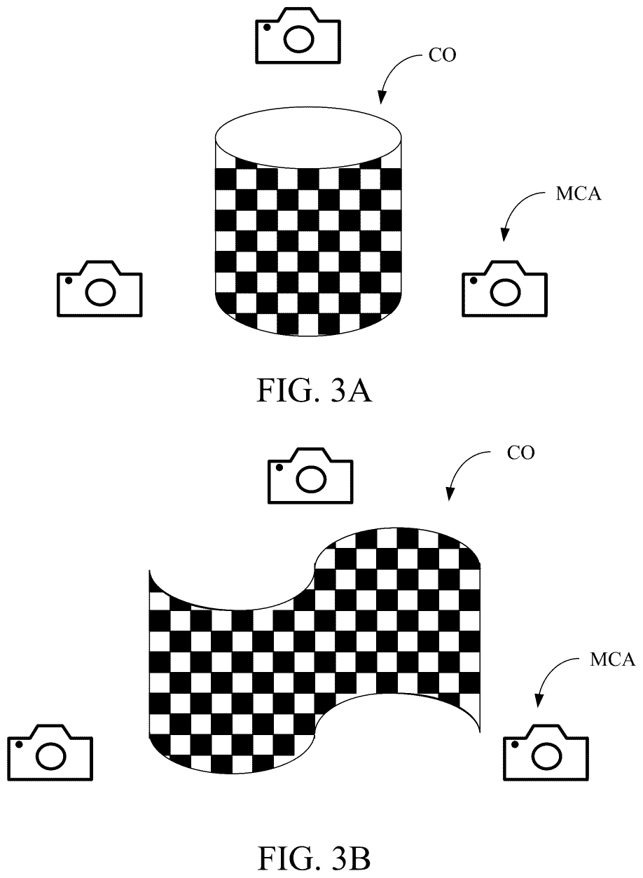

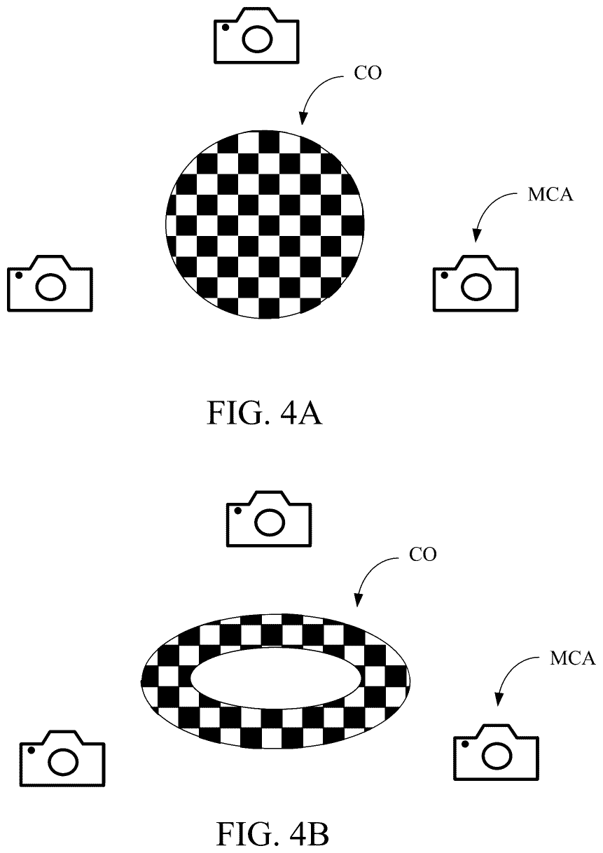

For ease of understanding, please refer to FIG. 3A to FIG. 4B, which respectively illustrate different implementation methods of the calibration object CO and corresponding operation schematic diagrams.

First, as shown in FIG. 3A, the calibration object CO may be the cylindrical shape, a multi-camera array MCA composed of a plurality of image capturing devices is disposed at an external position of the calibration object CO, and the image capturing devices are shooting inwards. In the present example, the feature pattern printed with high dpi can be flatly attached to the outer wall of a smooth plastic cylinder, and the size of the cylinder is determined according to the shooting distance. This embodiment can be applied to the calibration of a ring camera array shooting from outside to inside.

Next, as shown in FIG. 3B, the calibration object CO may be a curved shape, a multi-camera array MCA composed of a plurality of image capturing devices is disposed at an external position of the calibration object CO, and the image capturing devices are shooting inward. In the present example, an acrylic plate with a curved surface shape can be used as a carrier of the feature pattern, and the feature pattern is coated on the carrier through a film (for example, both sides have the feature pattern). This embodiment can be applied to the calibration of a ring camera array shooting from outside to inside.

Next, as shown in FIG. 4A, the calibration object CO may be a sphere shape, a multi-camera array MCA composed of a plurality of image capturing devices is disposed at an external position of the calibration object CO, and the image capturing devices are shooting inward. In the present example, the matte treated steel ball can be painted to create a feature pattern, and the size of the ball is determined by the shooting distance. This embodiment can be applied to the calibration of a ring camera array shooting from outside to inside.

In addition, as shown in FIG. 4B, the calibration object CO may be a ring shape, a multi-camera array MCA composed of a plurality of image capturing devices is disposed at an external position of the calibration object CO, and the image capturing devices are shooting inward. In the present example, a ring-shaped acrylic plate can be used as a feature pattern carrier, and the feature pattern can be coated on the carrier through a film. This embodiment can be applied to the calibration of a ring camera array shooting from outside to inside.

It shall be appreciated that the calibration object CO disclosed in the present invention includes at least one curved surface, and each curved surface can provide a wider recognizable field of view for the image capturing device. In other words, since each curved surface can provide a recognizable viewing angle of at least more than 180 degrees, the image capturing device in the system can obtain calibration image frames with feature patterns at more locations to perform corresponding calibration operations.

In some embodiments, the calibration object CO can be identified at all angles, so the multi-camera array has no blind spots for identification (i.e., the feature pattern can be captured at any position). In other words, there is no traditional flat calibration plate used for multi-camera array calibration, which will result in a 180-degree shooting limitation. Accordingly, panoramic calibration can be performed even if the fields of view of multiple cameras do not overlap.

In some embodiments, the at least one curved surface of the calibration object CO provides a recognizable viewing angle of 360 degrees. For example, the spherical calibration object shown in FIG. 4A.

In some embodiments, the at least one curved surface of the calibration object CO comprises only one continuous surface, and the continuous surface provides a recognizable viewing angle of 360 degrees. For example, the ring shape calibration object shown in FIG. 4B has only one continuous surface.

In some embodiments, the at least one curved surface of the calibration object CO comprises only two continuous surfaces, and each of the continuous surfaces provides a recognizable viewing angle exceeding 180 degrees. For example, the curved shape calibration object shown in FIG. 3B has two continuous surfaces (i.e., the front and rear surfaces).

Next, in the present embodiment, the processing device PD receives a plurality of calibration image frames from the image capturing devices, each of the calibration image frames at least comprises a feature sub-pattern on the at least one curved surface corresponding to the calibration object CO, and the feature sub-pattern is a part of the at least one feature pattern.

Finally, in the present embodiment, the processing device PD generates a calibration parameter of each of the image capturing devices based on the feature sub-pattern of each of the calibration image frames.

In some embodiments, the correction parameter includes an extrinsic correction parameter, an intrinsic correction parameter, or a combination thereof.

For example, the extrinsic correction parameters may include information such as rotation matrix, translation vector, projection matrix, position, and pose, etc. The intrinsic calibration parameters may include information such as focal length, principal point, distortion coefficients, pixel size, camera matrix, etc.

It shall be appreciated that the feature pattern has identifiable uniqueness. Therefore, in the present disclosure, the processing device PD only needs to identify a portion of the feature pattern to deduce the current position and posture of the image capturing device.

In some embodiments, the calibration parameters generated by the processing device PD describe the position and orientation of the image capturing device in the world coordinate system (i.e., the posture and position of the image capturing device). The processing device PD may calibrate a position information and a direction information corresponding to each of the image capturing devices based on the calibration parameters of each of the image capturing devices.

In some embodiments, as shown in FIG. 2, the processing device PD comprises the storage 13, and the storage 13 is electrically connected to the processor 11. The storage 13 is configured to store a plurality of viewing angle images corresponding to the calibration object CO and a position relationship and a device posture corresponding to each of the viewing angle images. The processing device PD can determine the viewing angle and position of the image capturing device by comparing the plurality of viewing angle images and the feature sub-pattern.

Specifically, the processor 11 compares the plurality of viewing angle images and the feature sub-pattern of each of the calibration image frames to determine the position relationship and the device posture of each of the plurality of image capturing devices. Next, the processor 11 generates the calibration parameter of each of the image capturing devices based on the position relationship and the device posture of each of the plurality of image capturing devices.

In some embodiments, the storage 13 may be configured to store a three-dimensional model corresponding to the calibration object CO, the three-dimensional model stores a plurality of viewing angles corresponding to the calibration object CO and a device posture corresponding to each of the viewing angles.

In some embodiments, the calibration parameter generating system 1 comprises an inside-out multi-camera array, the inside-out multi-camera array is composed of the plurality of image capturing devices, and the plurality of image capturing devices are located in an internal region of the calibration object CO.

In some embodiments, the calibration image frames correspond to a same first curved surface of the at least one curved surface of the calibration object CO.

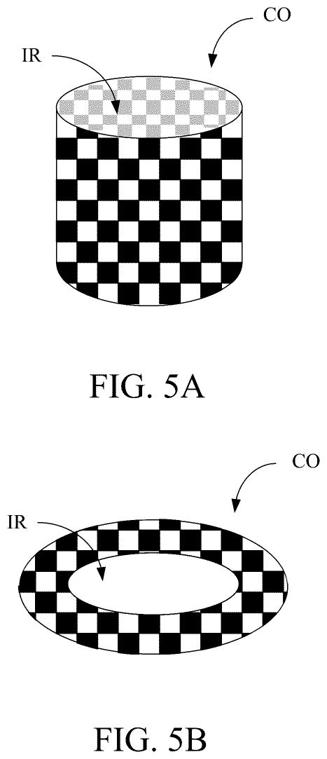

For example, as shown in FIG. 5A, the calibration object CO may be the cylindrical shape. In the present example, the feature pattern printed with high dpi can be flatly attached to the inner wall of a smooth plastic cylinder. When the inside-out multi-camera array is placed in the inner region IR, the camera array calibration can be performed by inside-out shooting, and the calibration image frames correspond to the same curved surface of the calibration object CO (i.e., the inner curved surface of the cylinder).

For another example, as shown in FIG. 5B, the calibration object CO may be the ring shape. In the present example, a ring-shaped acrylic plate can be used as a feature pattern carrier, and the feature pattern can be coated on the carrier through a film. When the inside-out multi-camera array is placed in the inner region IR, a camera array calibration can be performed by inside-out shooting, and the calibration image frames correspond to the same curved surface of the calibration object CO.

In some embodiments, in order to make the operation of the calibration parameters more accurate, the processing device PD can simultaneously consider the position information of different image capturing devices to obtain the relative distance relationship more accurately.

Specifically, the image capturing devices comprise a first image capturing device, a second image capturing device, and a third image capturing device. The processing device PD performs a panoramic calibration operation based on a positional relationship between any two of the image capturing devices and the feature sub-pattern of each of the calibration image frames to generate the calibration parameters of each of the image capturing devices.

According to the above descriptions, the calibration parameter generating system 1 provided by the present disclosure sets a calibration object including at least one curved surface in the system to provide each image capturing device in the system with a recognizable viewing angle without blind spots (i.e., the recognizable viewing angle is 360 degrees). Next, the processing device in the system generates a calibration parameter of each of the image capturing devices based on a plurality of calibration image frames including feature sub-patterns on the at least one curved surface of the calibration object. Since the calibration parameter generating system 1 provided by the present disclosure can provide a multi-camera array with a shooting angle greater than 180 degrees for panoramic calibration, a full-angle calibration effect can be achieved. In addition, the new calibration object structure solves the blind spot and viewpoint bias when using flat/polyhedron calibration charts. Accordingly, the calibration parameter generating system 1 provided by the present disclosure can correctly generate calibration parameters, thereby improving the accuracy of device execution operations and enhancing the user's service experience.

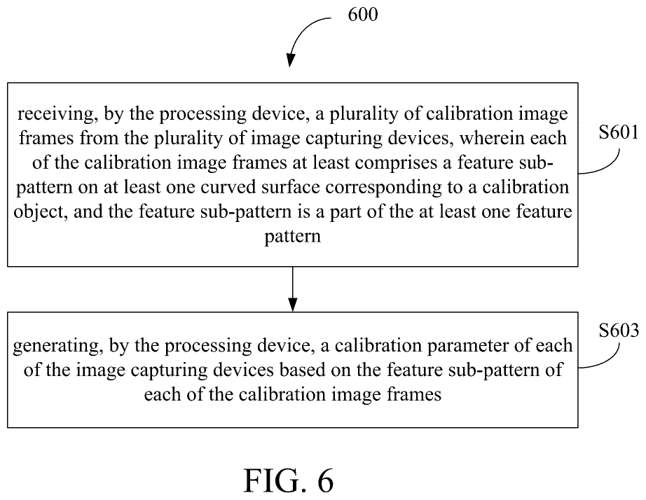

A second embodiment of the present disclosure is a calibration parameter generating method and a flowchart thereof is depicted in FIG. 6. The calibration parameter generating method 600 is adapted for a calibration parameter generating system (e.g., the calibration parameter generating system 1 of the first embodiment). The calibration parameter generating system comprises a calibration object, a plurality of image capturing devices, and a processing device (e.g., the calibration object CO, a plurality of image capturing devices ICD1, ICD2, . . . , ICDn, and a processing device PD of the first embodiment). The calibration object comprises at least one curved surface, and each of the at least one curved surface comprises at least one feature pattern. The calibration parameter generating method 600 generates a calibration parameter of each of the image capturing devices through the steps S601 to S603.

In the step S601, the processing device receives a plurality of calibration image frames from the plurality of image capturing devices, wherein each of the calibration image frames at least comprises a feature sub-pattern on the at least one curved surface corresponding to a calibration object, and the feature sub-pattern is a part of the at least one feature pattern.

Next, in the step S603, the processing device generates a calibration parameter of each of the image capturing devices based on the feature sub-pattern of each of the calibration image frames.

In some embodiments, the calibration parameter generating method 600 further comprises the following steps: calibrating a position information and a direction information corresponding to each of the image capturing devices based on the calibration parameter of each of the image capturing devices.

In some embodiments, the processing device further comprises a storage, the storage is configured to store a plurality of viewing angle images corresponding to the calibration object and a position relationship and a device posture corresponding to each of the viewing angle images, and the step of generating the calibration parameter of each of the image capturing devices further comprises the following steps: comparing, by the processing device, the plurality of viewing angle images and the feature sub-pattern of each of the calibration image frames to determine the position relationship and the device posture of each of the plurality of image capturing devices; and generating, by the processing device, the calibration parameter of each of the image capturing devices based on the position relationship and the device posture of each of the plurality of image capturing devices.

In some embodiments, the at least one curved surface of the calibration object provides a recognizable viewing angle of 360 degrees.

In some embodiments, the calibration parameter generating system comprises an inside-out multi-camera array, the inside-out multi-camera array is composed of the plurality of image capturing devices, and the plurality of image capturing devices are located in an internal region of the calibration object.

In some embodiments, the calibration image frames correspond to a same first curved surface of the at least one curved surface of the calibration object.

In some embodiments, the image capturing devices comprise a first image capturing device, a second image capturing device, and a third image capturing device, and the calibration parameter generating method 600 comprises the following steps: performing, by the processing device, a panoramic calibration operation based on a position relationship between any two of the image capturing devices and the feature sub-pattern of each of the calibration image frames to generate the calibration parameters of each of the image capturing devices.

In some embodiments, the calibration object corresponds to one of a cylindrical shape, a curved shape, a spherical shape, and a ring shape, or a combination thereof.

In some embodiments, the at least one curved surface of the calibration object comprises only one continuous surface, and the continuous surface provides a recognizable viewing angle of 360 degrees.

In some embodiments, the at least one curved surface of the calibration object comprises only two continuous surfaces, and each of the continuous surfaces provides a recognizable viewing angle exceeding 180 degrees.

In addition to the aforesaid steps, the second embodiment can also execute all the operations and steps of the calibration parameter generating system 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The calibration parameter generating method described in the second embodiment may be implemented by a computer program having a plurality of codes. The computer program may be a file that can be transmitted over the network, or may be stored into a non-transitory computer readable storage medium. After the codes of the computer program are loaded into an electronic apparatus (e.g., the calibration parameter generating system 1), the computer program executes the calibration parameter generating method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., the curved surface, the image capturing device) are preceded by terms such as “first”, “second”, or “third”, and these terms of “first”, “second”, or “third” are only used to distinguish these different words. For example, the “first” and “second” image capturing device are only used to indicate different image capturing devices in operation.

According to the above descriptions, the calibration parameter generation technology (at least including the system and the method) provided by the present disclosure sets a calibration object including at least one curved surface in the system to provide each image capturing device in the system with a recognizable viewing angle without blind spots (i.e., the recognizable viewing angle is 360 degrees). Next, the processing device in the system generates a calibration parameter of each of the image capturing devices based on a plurality of calibration image frames including feature sub-patterns on the at least one curved surface of the calibration object. Since the calibration parameter generating technology provided by the present disclosure can provide a multi-camera array with a shooting angle greater than 180 degrees for panoramic calibration, a full-angle calibration effect can be achieved. In addition, the new calibration object structure solves the blind spot and viewpoint bias when using flat/polyhedron calibration charts. Accordingly, the calibration parameter generating technology provided by the present disclosure can correctly generate calibration parameters, thereby improving the accuracy of device execution operations and enhancing the user's service experience.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A calibration parameter generating system, comprising:
a calibration object, wherein the calibration object comprises at least one curved surface, and each of the at least one curved surface comprises at least one feature pattern;
a plurality of image capturing devices; and
a processing device, being communicatively connected to the plurality of image capturing devices, and being configured to perform operations comprising:
receiving a plurality of calibration image frames from the plurality of image capturing devices, wherein each of the calibration image frames at least comprises a feature sub-pattern on the at least one curved surface corresponding to a calibration object, the at least one curved surface of the calibration object provides a recognizable viewing angle of 360 degrees, and the feature sub-pattern is a part of the at least one feature pattern; and
generating a calibration parameter of each of the image capturing devices based on the feature sub-pattern of each of the calibration image frames.

2. The calibration parameter generating system of claim 1, wherein the processing device is further configured to perform the following operations:
calibrating a position information and a direction information corresponding to each of the image capturing devices based on the calibration parameter of each of the image capturing devices.

3. The calibration parameter generating system of claim 1, wherein the processing device further comprises:
a storage, being configured to store a plurality of viewing angle images corresponding to the calibration object and a position relationship and a device posture corresponding to each of the viewing angle images;
wherein the operation of generating the calibration parameter of each of the image capturing devices further comprises the following operations:
comparing the plurality of viewing angle images and the feature sub-pattern of each of the calibration image frames to determine the position relationship and the device posture of each of the plurality of image capturing devices; and
generating the calibration parameter of each of the image capturing devices based on the position relationship and the device posture of each of the plurality of image capturing devices.

4. (canceled)

5. The calibration parameter generating system of claim 1, wherein the calibration parameter generating system comprises an inside-out multi-camera array, the inside-out multi-camera array is composed of the plurality of image capturing devices, and the plurality of image capturing devices are located in an internal region of the calibration object.

6. The calibration parameter generating system of claim 5, wherein the calibration image frames correspond to a same first curved surface of the at least one curved surface of the calibration object.

7. The calibration parameter generating system of claim 1, wherein the image capturing devices comprise a first image capturing device, a second image capturing device, and a third image capturing device, and the processing device further performs the following operations:
performing a panoramic calibration operation based on a position relationship between any two of the image capturing devices and the feature sub-pattern of each of the calibration image frames to generate the calibration parameters of each of the image capturing devices.

8. The calibration parameter generating system of claim 1, wherein the calibration object corresponds to one of a cylindrical shape, a curved shape, a spherical shape, and a ring shape, or a combination thereof.

9. The calibration parameter generating system of claim 1, wherein the at least one curved surface of the calibration object comprises only one continuous surface, and the continuous surface provides the recognizable viewing angle of 360 degrees.

10. The calibration parameter generating system of claim 1, wherein the at least one curved surface of the calibration object comprises only two continuous surfaces, and each of the continuous surfaces provides the recognizable viewing angle exceeding 180 degrees.

11. A calibration parameter generating method, being adapted for use in a calibration parameter generating system, wherein the calibration parameter generating system comprises a calibration object, a plurality of image capturing devices, and a processing device, the calibration object comprises at least one curved surface, and each of the at least one curved surface comprises at least one feature pattern, and the calibration parameter generating method comprises:
receiving, by the processing device, a plurality of calibration image frames from the plurality of image capturing devices, wherein each of the calibration image frames at least comprises a feature sub-pattern on the at least one curved surface corresponding to a calibration object, the at least one curved surface of the calibration object provides a recognizable viewing angle of 360 degrees, and the feature sub-pattern is a part of the at least one feature pattern; and
generating, by the processing device, a calibration parameter of each of the image capturing devices based on the feature sub-pattern of each of the calibration image frames.

12. The calibration parameter generating method of claim 11, wherein the calibration parameter generating method further comprises the following steps:
calibrating a position information and a direction information corresponding to each of the image capturing devices based on the calibration parameter of each of the image capturing devices.

13. The calibration parameter generating method of claim 11, wherein the processing device further comprises a storage, the storage is configured to store a plurality of viewing angle images corresponding to the calibration object and a position relationship and a device posture corresponding to each of the viewing angle images, and the step of generating the calibration parameter of each of the image capturing devices further comprises the following steps:
comparing, by the processing device, the plurality of viewing angle images and the feature sub-pattern of each of the calibration image frames to determine the position relationship and the device posture of each of the plurality of image capturing devices; and
generating, by the processing device, the calibration parameter of each of the image capturing devices based on the position relationship and the device posture of each of the plurality of image capturing devices.

14. (canceled)

15. The calibration parameter generating method of claim 11, wherein the calibration parameter generating system comprises an inside-out multi-camera array, the inside-out multi-camera array is composed of the plurality of image capturing devices, and the plurality of image capturing devices are located in an internal region of the calibration object.

16. The calibration parameter generating method of claim 15, wherein the calibration image frames correspond to a same first curved surface of the at least one curved surface of the calibration object.

17. The calibration parameter generating method of claim 11, wherein the image capturing devices comprise a first image capturing device, a second image capturing device, and a third image capturing device, and the calibration parameter generating method comprises the following steps:
performing, by the processing device, a panoramic calibration operation based on a position relationship between any two of the image capturing devices and the feature sub-pattern of each of the calibration image frames to generate the calibration parameters of each of the image capturing devices.

18. The calibration parameter generating method of claim 11, wherein the calibration object corresponds to one of a cylindrical shape, a curved shape, a spherical shape, and a ring shape, or a combination thereof.

19. The calibration parameter generating method of claim 11, wherein the at least one curved surface of the calibration object comprises only one continuous surface, and the continuous surface provides the recognizable viewing angle of 360 degrees.

20. The calibration parameter generating method of claim 11, wherein the at least one curved surface of the calibration object comprises only two continuous surfaces, and each of the continuous surfaces provides the recognizable viewing angle exceeding 180 degrees.
